(19) United States
(12) Patent Application Publication
(10) Pub. No.: US 2018/0133799 A1
(43) Pub. Date: May 17, 2018

(54) APPARATUS FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Jens STAMMBERGER, Rodental (DE); Daniel Winiarski, Bad Straffelstein (DE)

(73) Assignee: CL SCHUTZRECHTSVERWALTUNGS GMBH, Lichtenfels (DE)

(21) Appl. No.: 15/813,560

(22) Filed: Nov. 15, 2017

(30) Foreign Application Priority Data
Nov. 15, 2016 (DE) 102016121951.7

(51) Int. Cl. B22F 3/105; B33Y 30/00

(52) U.S. Cl. CPC B22F 3/1055; B22F 2003/1056; B33Y 30/00

(57) ABSTRACT

An apparatus (1) for additive manufacturing of three-dimensional objects (2) by successive, selective layer-by-layer exposure and thus successive, selective layer-by-layer solidification of construction material layers of a construction material (3) that can be solidified by means of a laser beam (4), comprising a process chamber (7), in which the successive, selective layer-by-layer exposure and thus the successive, selective layer-by-layer exposure of respective construction material layers of a construction material (3) that can be solidified by means of a laser beam (4) is carried out, and an exposure device (6) provided for generating a laser beam (4) for the selective exposure and thus solidification of respective construction material layers, wherein the exposure device (6) is arranged or formed on a housing construction (11) in a heat-decoupled manner spaced apart from the process chamber (7).

An apparatus for additive manufacturing of three-dimensional objects by successive, selective layer-by-layer exposure and thus successive, selective layer-by-layer solidification of construction material layers of a construction material that can be solidified by means of a laser beam, comprising a process chamber and an exposure device, comprising the further features of the preamble of claim 1.

Respective apparatuses for additive manufacturing of three-dimensional objects, e.g. in the form of apparatuses for performing selective laser sintering methods or selective laser melting methods, are per se known. Respective apparatuses comprise a process chamber, in which the successive, selective layer-by-layer exposure and thus the successive, selective layer-by-layer solidification of respective construction material layers is carried out, and an exposure device provided for generating a laser beam for the selective exposure and thus solidification of respective construction material layers.

The process heat that is produced related to the process while operating respective apparatuses causes a heating of the process chamber. Until now, it has been common to arrange the exposure device directly at or on an exposed outer surface of the process chamber, so that the heating and thus the thermal expansion of the process chamber can inevitably result in a certain change in the positioning of the exposure device to be accurately positioned or accurately positioned.

This is a condition that could be improved, since changes in the positioning of the exposure device can negatively effect an accurate exposure of respective construction material layers to be selectively exposed or to be selectively solidified and thus the quality of the objects to be manufactured.

The invention is based on the object of providing, in contrast to the above, an improved apparatus for manufacturing of three-dimensional objects.

The object is solved by an apparatus for additive manufacturing of three-dimensional objects according to claim 1. The dependent claims relate to possible embodiments of the apparatus.

The apparatus described herein (“apparatus”) is provided for additive manufacturing of three-dimensional objects, i.e., for example, technical components or technical component groups, respectively, by successive, selective layer-by-layer exposure and thus successive, selective layer-by-layer solidification of construction material layers of a construction material that can be solidified by means of a laser beam. The construction material can especially be a particulate or powdered metal material, plastic material, and/or ceramic material. The selective solidification of respective construction material layers to be selectively solidified is carried out based on object-related construction data. Respective construction data describe the geometric structural design of the respective object to be additively manufactured and can, for example, include “sliced” CAD data of the object to be additively manufactured. The apparatus can be formed as an SLM apparatus, i.e. as an apparatus for performing selective laser melting methods (SLM methods), or as an SLS apparatus, i.e. as an apparatus for performing selective laser sintering methods (SLS methods).

The apparatus comprises the functional components typically required for performing additive construction processes. This especially involves a coating device and an exposure device. The coating device is provided for forming construction material layers to be selectively solidified (in the construction plane of the apparatus). The coating device can comprise several components, i.e., for example, a coating element comprising an, especially blade-shaped, coating tool, and a guiding device for guiding the coating element along a defined trajectory.

The exposure device is provided for generating a laser beam for the selective exposure and thus solidification of respective construction material layers (in the construction plane of the apparatus). The exposure device can also comprise several components, i.e., for example, a beam generation device for generating a laser beam, a beam deflection device (scanner device) for deflecting a laser beam generated by the beam generation device to a section to be selectively exposed of a construction material layer to be selectively solidified, and various optical elements, such as filter elements, objective elements, lens elements, etc. The exposure device can also be referred to as or considered optics of the apparatus.

The exposure device is arranged or formed on a housing construction formed by or comprising one or more, especially profile-like or profile-shaped, frame construction elements in a heat-decoupled manner spaced apart from the process chamber. An arrangement or formation of the exposure device in a heat-decoupled, spaced-apart manner, i.e. especially a beam deflection device associated with the exposure device, relative to the process chamber is understood to mean that no heat (thermal energy), which could possibly lead to an undesired change in positioning, i.e. in orientation and/or arrangement, of the exposure device, can be transferred from the process chamber to the exposure device. The exposure device is spatially spaced apart from the process chamber such that no heat transfer from the process chamber to the exposure device is possible. The exposure device is from the thermal point of view entirely decoupled from the process chamber; a heat transfer from the process chamber to the exposure device (and vice versa) is not possible.

Thus, between the exposure device and the process chamber typically a gap is formed defining a distance between the exposure device and the process chamber. The gap can define a distance between the exposure device and the process chamber of a few millimeters, i.e. especially a distance of at least one millimeter. Thus, between the exposure device and the process chamber there is typically no physical, i.e. especially no mechanical, contact which might enable a heat transfer from the process chamber to the exposure device.

The problem described in connection with the prior art described at the beginning is addressed in such a way that it is not possible with the exposure device arranged or formed in a heat-decoupled manner spaced apart from the process chamber that the process chamber heating up due to the process heat that is produced while operating respective apparatuses has a negative effect on the positioning of the exposure device.

The exposure device is arranged on a frame construction. The frame construction can be an outer housing frame construction of the apparatus, typically forming a (closed) housing or covering construction of the apparatus and thus (significantly) defining the outer design of the apparatus. As it follows from below, there are other embodiments according to which the frame construction, to which the exposure device is arranged or formed, is not the outer housing frame construction of the apparatus.

In terms of arranging or forming the exposure device on the frame construction, there are different options that are explained in more detail below.

The apparatus can e.g. comprise a (common) frame construction, on which the exposure device and the process chamber are arranged or formed. The exposure device is arranged or formed on the frame construction spaced apart from the process chamber such that a change in the positioning of the exposure device on the frame construction is not carried out or not possible due to the thermal energy brought into the frame construction while operating the apparatus via the process chamber. The thermal energy brought into the frame construction while operating the apparatus via the process chamber is simply not enough, especially due to thermal expansion, to cause an undesired change in the positioning of the exposure device.

This can structurally, e.g., be realized such that the exposure device is arranged or formed on at least one first frame construction portion and the process chamber is arranged or formed on at least one other frame construction portion, wherein the at least one first frame construction portion is arranged or formed spaced apart from the at least one other frame construction portion such that no change in the positioning of the exposure device on the frame construction due to the thermal energy brought into the frame construction via the process chamber in operation of the apparatus is effected or possible.

Alternatively, the apparatus can comprise several separate frame constructions arranged in a heat-decoupled manner spaced apart from each other, wherein the exposure device is arranged or formed on a first frame construction and the process chamber is arranged or formed on a second frame construction. In this connection, an arrangement of respective frame constructions in a heat-decoupled, spaced-apart manner is to be understood to mean that no heat (thermal energy), which could possibly lead to an undesired change in the positioning, i.e. the orientation and/or arrangement, of the exposure device, can be transferred from the second frame construction to the first frame construction. The respective frame constructions are spatially spaced apart from each other such that no heat transfer from the second frame construction to the first frame construction is possible.

The respective frame constructions can be arranged into each other, wherein the second frame construction has constructional-structurally smaller dimensions than the first frame construction. The second frame construction can insofar be considered or referred to as inner frame construction, the first frame construction as outer frame construction. This enables a compact, nevertheless heat-decoupled arrangement of respective frame constructions. The inner space defined by the first or the outer frame construction can possibly be inertable.

The exposure device can be arranged or formed on a separate frame construction portion or a separate frame construction element, which is formed of a material, especially a metal, having a coefficient of thermal expansion in a range between 0.5 and 3.0·×10⁻⁶K⁻¹. A respective material can e.g. be an iron-nickel alloy, also known by the name “Invar”, the coefficient of thermal expansion thereof (in a temperature range between 20 and 90° C.) is between 0.5 and 2.0×10⁻⁶K⁻¹. At this point it is generally to be noted that the frame construction, on which the exposure device is arranged or formed, is purposefully formed of a material having a comparatively low coefficient of thermal expansion (coefficient of linear expansion or coefficient of volumetric expansion).

As mentioned, between the exposure device and the process chamber a gap is typically formed defining a distance between the exposure device and the process chamber. In the gap at least one shielding element arranged or formed between the exposure device, especially a laser beam decoupling point of the exposure device or a beam deflection device associated with it, via which a laser beam decouples from or exits the exposure device, especially a beam deflection device associated with the exposure device, and a laser beam coupling point, especially a laser beam coupling window, via which a laser beam couples or enters into a process chamber interior space defined by the process chamber, for shielding the laser beam extending between the exposure device, especially the laser beam exiting point of the exposure device, and the process chamber, especially the laser beam coupling point of the process chamber, can be arranged or formed. The shielding element can have a corrugated bellows-like or corrugated bellows-shaped or sleeve-like or sleeve-shaped geometric-structural design and is formed of a suitable shielding material, i.e., for example, glass, steel, etc. The shielding element ensures a shielding of the apparatus, i.e., it prevents the laser beam from undesirably exiting the apparatus, especially via the gap extending between the exposure device and the process chamber.

For the same purpose, it is also conceivable that a shielding housing construction is arranged or formed, comprising at least one, especially planar, shielding element, which is arranged or formed around the frame construction, on which the exposure device is arranged or formed. The shielding housing construction is an enclosure of at least the frame construction, on which the exposure device is arranged or formed, preventing the laser beam from undesirably exiting the apparatus, especially via the gap extending between the exposure device and the process chamber.

The invention is explained in more detail by means of exemplary embodiments in the figures of the drawings. In which:

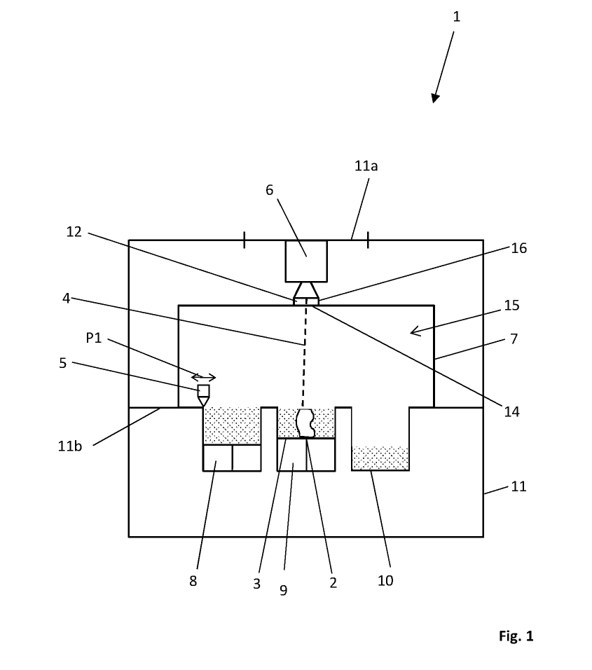

FIGS. 1-3 each show a schematic diagram of an apparatus according to an exemplary embodiment.

FIGS. 1-3 each show a schematic diagram of an apparatus 1 according to an exemplary embodiment of the apparatus 1.

The apparatus 1 serves the additive manufacturing of three-dimensional objects 2, i.e. especially technical components or technical component groups, by successive, selective layer-by-layer exposure and thus successive, selective layer-by-layer solidification of construction material layers of a construction material 3, i.e., for example, a metal powder, that can be solidified by means of laser radiation, cf. laser beam 4. The selective solidification of respective construction material layers to be solidified is carried out based on object-related construction data. Respective construction data describe the geometric or geometric structural design of the respective object 2 to be additively manufactured and can, for example, include “sliced” CAD data of the object 2 to be manufactured. The apparatus 1 can be formed as a Laser-CUSING® apparatus, i.e. as an apparatus for performing selective laser melting methods.

The apparatus 1 comprises the functional components required for performing additive construction processes; in the figures, for example, only a coating device 5 and an exposure device 6 are shown.

The coating device 5 is provided for forming construction material layers to be selectively exposed or to be selectively solidified in a construction plane of the apparatus 1. The coating device 5 comprises a coating element assembly (not denoted in more detail) comprising several coating elements, which is movably supported in horizontal direction in a process chamber 7 of the apparatus 1, as indicated by the double arrow P1, via a guiding device (not shown).

The coating device 6 is provided for the selective exposure of construction material layers in the construction plane of the apparatus 1 to be selectively solidified and for that purpose comprises a beam generation device (not shown) provided for generating a laser beam 4, a beam deflection device (not shown) provided for deflecting a laser beam 4 generated by the beam generation device to a section to be exposed, of a construction material layer to be selectively solidified, and various optical elements, such as filter elements, objective elements, lens elements, etc. The exposure device 6 can also be referred to as or considered optics of the apparatus 1.

In the figures, a metering module 8, a construction module 9 and an overflow module 10 are further illustrated, which are docked to a lower section of the process chamber 7 of the apparatus 1. The modules mentioned can also form a lower section of the process chamber 7.

The exposure device 6 is arranged on a housing construction 11 formed by or comprising one or more, e.g. profile-like or profile-shaped, frame construction elements (not denoted in more detail) in a heat-decoupled manner spaced apart from the process chamber 7. An arrangement or formation of the exposure device 6 in a heat-decoupled, spaced-apart manner, i.e. especially the beam deflection device associated with the exposure device 6, relative to the process chamber 7 is understood to mean that no heat (thermal energy), which could possibly lead to an undesired change in positioning, i.e. the orientation and/or arrangement, of the exposure device 6 (e.g. relative to a reference positioning), can be transferred from the process chamber 7 to the exposure device 6. The exposure device 6 is spatially spaced from the process chamber 7 such that no heat transfer from the process chamber 7 to the exposure device 6 is possible. The exposure device 6 is, from the thermal point of view, completely decoupled from the process chamber 7.

Evidently, between the exposure device 6 and the process chamber 7 a gap 12 is formed defining a distance between the exposure device 6 and the process chamber 7. The gap 12 can define a distance of a few millimeters, i.e. especially a distance of at least one millimeter. Thus, between the exposure device 6 and the process chamber 7 there is no physical, i.e. especially no mechanical, contact which might enable a heat transfer from the process chamber 7 to the exposure device 6.

In other words, with the arrangement of the exposure device 6 in a heat-decoupled, spaced-apart manner from the process chamber 7 it is not possible that the heating of the process chamber 7 due to process heat that is produced while operating the apparatus 1 has a negative effect on the positioning of the exposure device 6.

In the exemplary embodiment shown in FIG. 1, the exposure device 6 is arranged on a frame construction 11, which forms an outer housing frame construction of the apparatus 1. The housing frame construction forms the (closed) housing or covering construction of the apparatus 1 and thus (essentially) defines the outer design of the apparatus 1.

In the exemplary embodiment shown in FIG. 1, the process chamber 7 is also arranged on the frame construction 11. The apparatus 1 thus comprises a (common) frame construction 11, on which the exposure device 6 and the process chamber 7 are arranged. The exposure device 6 is arranged on the frame construction 11 spaced apart from the process chamber 7 such that a change in the positioning of the exposure device 6 on the frame construction 11 due to the thermal energy brought into the frame construction 11 while operating the apparatus 1 via the process chamber 7 is not carried out or is not possible. The exposure device 6 is arranged spaced apart from the process chamber 7 such that the thermal energy brought into the frame construction 11 while operating the apparatus 1 via the process chamber 7 is simply not enough, especially due to thermal expansion, to cause an undesired change in the positioning of the exposure device 6.

This is structurally realized such that the exposure device 6 is arranged on a first frame construction portion 11a and the process chamber 7 on another frame construction portion 11b, wherein the first frame construction portion 11a is arranged or formed spaced apart from the other frame construction portion 11b such that no change in the positioning of the exposure device 6 on the frame construction 11 due to the thermal energy brought into the frame construction 11 via the process chamber 7 in operation of the apparatus 1 is effected or possible.

Further illustrated in the exemplary embodiment shown in FIG. 1 is the opportunity that the exposure device 6 is arranged on a separate frame construction portion (first frame construction portion 11a) or on a separate frame construction element of the frame construction 11, which is formed of a material, especially a metal, having a coefficient of thermal expansion in a range between 0.5 and 3.0·×10⁻⁶K⁻¹. A respective material can e.g. be an iron-nickel alloy, also known by the name “Invar”, the coefficient of thermal expansion thereof (in a temperature range between 20 and 90° C.) is between 0.5 and 2.0×10⁻⁶K⁻¹.

Finally, in the exemplary embodiment shown in FIG. 1, the opportunity is shown that in the gap 12 a shielding element 16 arranged or formed between the exposure device 6, especially a laser beam decoupling point (not denoted in more detail) of the exposure device 6 or the beam deflection device associated with that, via which a laser beam 4 decouples from or exits the exposure device 6, especially a beam deflection device associated with the exposure device 6, and a laser beam coupling point (not denoted in more detail), especially a laser beam coupling window 14, via which a laser beam 4 couples or enters into a process chamber interior space 15 defined by the process chamber 7, for shielding the laser beam 4 extending between the exposure device 6, especially the laser beam exiting point of the exposure device 6, and the process chamber 7, especially the laser beam coupling point of the process chamber 7, is arranged. The shielding element 16 has a corrugated bellows-like or sleeve-like geometric-structural design and is formed of a suitable shielding material, i.e., for example, glass, steel, etc. The shielding element 16 ensures a shielding of the apparatus 1, i.e., it prevents the laser beam 4 from undesirably exiting the apparatus 1, especially via the gap 12 extending between the exposure device and the process chamber.

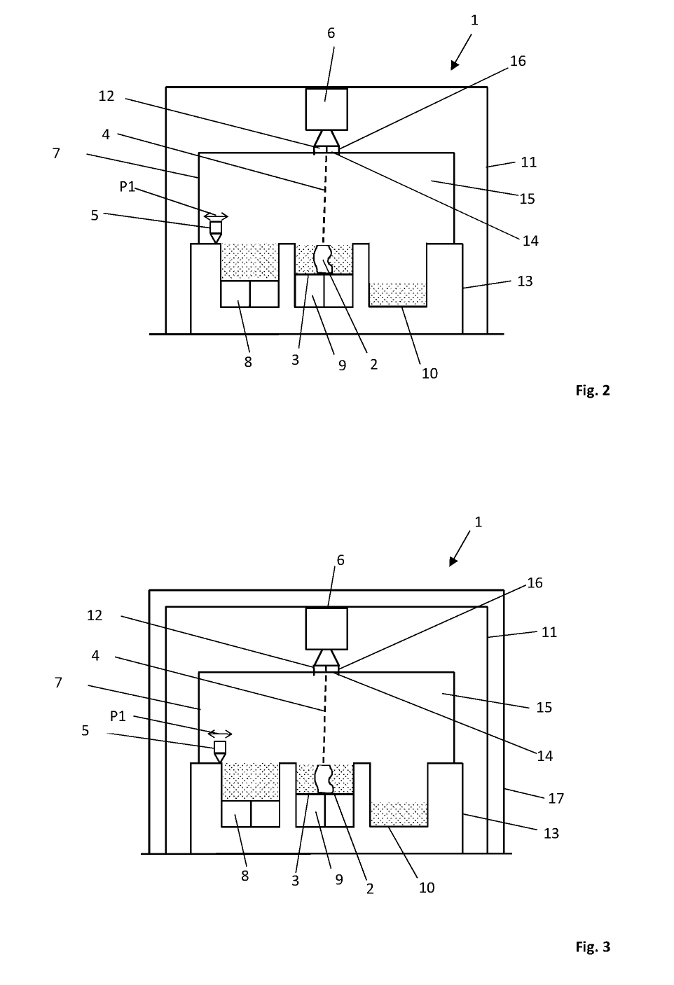

In the exemplary embodiment shown in FIG. 2, the apparatus 1 comprises several separate frame constructions 11, 13 arranged in a heat-decoupled manner spaced apart from each other. The exposure device 6 is arranged on a first frame construction 11 and the process chamber 7 is arranged on a second frame construction 13. An arrangement of respective frame constructions 11, 13 in a heat-decoupled, spaced-apart manner is also to be understood to mean that no heat (thermal energy), which possibly could lead to an undesired change in the positioning of the exposure device 6, can be transferred from the second frame construction 13 to the first frame construction 11. The respective frame constructions 11, 13 are spatially spaced apart from each other such that no heat transfer from the second frame construction 13 to the first frame construction 11 is possible.

Both frame constructions 11, 13 are arranged into each other in the exemplary embodiment shown in FIG. 2. The second frame construction 13 has constructional-structurally lower dimensions than the first frame construction 11. The second frame construction 13 can insofar be considered or referred to as inner frame construction, the first frame construction 11 as outer frame construction. The inner space defined by the first or the outer frame construction 11 can possibly be inertable.

In the exemplary embodiment shown in FIG. 3, to ensure a shielding of the apparatus 1, i.e. prevent the laser beam 4 from undesirably exiting the apparatus 1, especially via the gap 12 extending between the exposure device 6 and the process chamber 7, a shielding housing construction 17 comprising at least one, especially planar, shielding element (not denoted in more detail) formed of a suitable shielding material, e.g. steel, is arranged, which is arranged around the frame construction 11, on which the exposure device 6 is arranged. The shielding housing construction 17 is an enclosure of the frame construction 11, on which the exposure device 6 is arranged, preventing the laser beam 4 from undesirably exiting the apparatus 1, especially via the gap 12 extending between the exposure device 6 and the process chamber 7.

1. An apparatus (1) for additive manufacturing of three-dimensional objects (2) by successive, selective layer-by-layer exposure and thus successive, selective layer-by-layer solidification of construction material layers of a construction material (3) that can be solidified by means of a laser beam (4), comprising
a process chamber (7), in which the successive, selective layer-by-layer exposure and thus the successive, selective layer-by-layer solidification of respective construction material layers of a construction material (3) that can be solidified by means of a laser beam (4) is carried out, and
an exposure device (6) provided for generating a laser beam (4) for the selective exposure and thus solidification of respective construction material layers, characterized in that
the exposure device (6) is arranged or formed on a housing construction (11) in a heat-decoupled manner spaced apart from the process chamber (7).

2. The apparatus according to claim 1, characterized in that the apparatus (1) comprises a frame construction (11), on which the exposure device (6) and the process chamber (7) are arranged or formed, wherein the exposure device (6) is arranged or formed on the frame construction (11) spaced apart from the process chamber (7) such that no change in the positioning of the exposure device (6) on the frame construction (11) due to the thermal energy brought into the frame construction (11) via the process chamber (7) in operation of the apparatus (1) is effected.

3. The apparatus according to claim 2, characterized in that the exposure device (6) is arranged or formed on at least one first frame construction portion (11a) and the process chamber (7) is arranged or formed on at least one other frame construction portion (11b), wherein the at least one first frame construction portion (11a) is arranged or formed spaced apart from the at least one other frame construction portion (11b) such that no change in the positioning of the exposure device (6) on the frame construction (11) due to the thermal energy brought into the frame construction (11) via the process chamber (7) in operation of the apparatus (1) is effected.

4. The apparatus according to claim 1, characterized in that the apparatus comprises several separate frame constructions (11, 13) arranged in a heat-decoupled manner spaced apart from each other, wherein the exposure device (6) is arranged or formed on a first frame construction (11) and the process chamber (7) is arranged or formed on a second frame construction (13).

5. The apparatus according to claim 1, characterized in that the exposure device (6) is arranged or formed on a separate frame construction portion (11a) formed of a material, especially a metal, having a coefficient of thermal expansion in a range between 0.5 and3.0×19 10⁻⁶K⁻¹.

6. The apparatus according to claim 1, characterized in that between the exposure device (6) and the process chamber (7) a gap (12) is formed defining a distance between the exposure device (6) and the process chamber (7).

7. The apparatus according to claim 6, characterized by at least one, especially corrugated bellows-like or sleeve-like, shielding element (16) arranged or formed between the exposure device (6), especially a laser beam decoupling point of the exposure device (6), via which a laser beam (4) decouples from the exposure device (6), especially a beam deflection device associated with the exposure device (6), and a laser beam coupling point, via which a laser beam (4) couples into a process chamber interior space (15) defined by the process chamber (7) for shielding the laser beam (4) extending between the exposure device (6), especially the laser beam exiting point of the exposure device (6), and the process chamber (7), especially the laser beam coupling point of the process chamber (7).

8. The apparatus according to claim 1, characterized by a shielding housing construction (17) comprising at least one shielding element (16), which is arranged or formed around the frame construction (11), on which the exposure device (6) is arranged or formed.
